(19) United States
(12) Patent Application Publication
(10) Pub. No.: US 2020/0004815 A1
(43) Pub. Date: Jan. 2, 2020

(54) TEXT ENTITY DETECTION AND RECOGNITION FROM IMAGES

(71) Applicant: Microsoft Technology Licensing, LLC, Redmond, WA (US)

(72) Inventors: Joshua B. WEISBERG, Redmond, WA (US); Chintan A. SHAH, Redmond, WA (US); Noranart VESDAPUNT, Bellevue, WA (US)

(73) Assignee: Microsoft Technology Licensing, LLC, Redmond, WA (US)

(21) Appl. No.: 16/023,432

(22) Filed: Jun. 29, 2018

(51) Int. Cl. G06F 17/27; G06K 9/00; G06K 9/62; G06N 5/04

(52) U.S. Cl. CPC G06F 17/278; G06K 9/00469; G06K 2209/01; G06N 5/046; G06K 9/6269

(57) ABSTRACT

Named entity recognition can be performed on an image to classify any text in an image. A boundary that encompasses the classified entity may be predicted. Subsequently, upon request, optical character recognition (OCR) can be performed on just the region inside the boundary. The disclosed implementations conserve computer resources such as processing power and battery compared to performing OCR on the entire image.

### FIELD OF THE DISCLOSURE

The present disclosure relates generally to a classification and named entity recognition system and process.

### BACKGROUND

There are many instances in which a semantic understanding of text within an image is desirable. For example, it may be useful to determine that a block of text is a specific named entity such as a phone number or a specific dollar amount on a receipt. Current mechanisms for identifying a named entity involve performing optical character recognition (OCR) on all text in a given image, and then applying one or more models to understand the text. OCR can refer to the conversion of handwritten or printed text into a machine-readable text. OCR typically utilizes a machine learning algorithm or a neural network to identify text, but it can require multiple models to understand the text and classify the text and/or document from which the text is extracted. Thus, in order to recognize specific text entities in an image, a multistep process may be performed, beginning with object detection and recognition, OCR, layout understanding, and finally named entity recognition (e.g., a phone number, a name, a business name, an email address, a uniform resource locator (URL), etc.).

To support new types of entities, a new model may be trained for each step other than OCR, which can require substantial data collection and annotation. For example, to convert an image of a business card to segmented and digitized text, can involve several steps. First, the process may require training an object classifier to detect and recognize business cards in images, which may require images of many different types of business cards. Next, OCR can be performed on the entire card. OCR can detect text in an image and extract the recognized text into a machine-readable character stream. OCR output can contain mapping from text to lines, lines to words, and words to characters. After performing OCR on the business card, an additional model may be employed to understand the layout of the text, and specify the entity type of each bit of text (e.g., named entity recognition). Named entity recognition may combine the OCR output with a dictionary search, and trained models to assign labels to words. Another model may be trained to understand the layout of business cards. The output of the named entity recognition may be insufficient to guarantee reliable results because it does not incorporate any contextual information (e.g., a business card typically has a family name appearing after a first name.

This approach can have several issues. Each type of object (e.g., a business card, a receipt, a handwritten note, a document, a web page, etc.) can require a new model to be trained for each object classifier, layout understanding, and entity recognition. Many types of objects, such as documents or business cards, can be difficult to classify or contain unstructured text. In addition, the approach requires that text is first identified through an OCR operation, which can involve performing OCR on all of the text in an image of the object. Developing, maintaining, and training these models, as well as performing OCR in such a process can require significant computing resources. This is undesirable in devices with limited battery and/or processing power such as mobile phones, tablets, or laptop computers, where one or more of the above-mentioned processes can be slow or so intensive that it drains the device's battery.

### SUMMARY

According to an embodiment, a system is disclosed that includes at least one computer readable device storing instructions, and one or more hardware processors that are coupled to the at least computer readable device. The one or more processors may be configured to execute the instructions to cause the system to perform operations including the following. An image that includes one or more entities may be received. A neural network may be used to determine a boundary of one of the one or more entities of the image that includes text. A classification of the text of the one of the plurality of entities of the image may be predicted. The classification of the text may be output. A request to perform an action based upon the classification of the text may be received. The request may include a gesture, a touch input, or a selection. The action may be performed in accordance with the request. An action may refer to, without limitation, making a telephone call, adding contact information, storing information to the computer readable device; searching the Internet, preparing an email message, navigating to a home address, preparing a text message, and opening a web browser to a web page.

In some configurations of the implementations disclosed herein, more than one boundary may be generated for an object. In some configurations, the one or more boundaries and/or entities of the image may be visually indicated. The request may refer to a selection of the visual indication. In some instances, OCR may be performed on a region within the boundary. The OCR may be performed subsequent to the request.

For any one of the implementations disclosed herein, the neural network may be generated by the following series of operations. One or more input images may be received. A portion of the input images may include at least one known entity. A prediction of a boundary for each of the at least one known entity may be generated based upon the layers in a neural network in which one of the layers includes a deconvolution layer.

In an implementation, a computer-implemented method is disclosed. An image that includes one or more entities may be received. A neural network may be used to determine a boundary of one of the one or more entities of the image that includes text. A classification of the text of the one of the plurality of entities of the image may be predicted. The classification of the text may be output. A request to perform an action based upon the classification of the text may be received. The request may include a gesture, a touch input, or a selection. The action may be performed in accordance with the request. An action may refer to, without limitation, making a telephone call, adding contact information, storing information to the computer readable device; searching the Internet, preparing an email message, navigating to a home address, preparing a text message, and opening a web browser to a web page.

In an implementation, a computer readable device is disclosed. The computer readable device may store machine-readable instructions that, when executed by one or more processors, cause the one or more processors to perform the following operations. An image that includes one or more entities may be received. A neural network may be used to determine a boundary of one of the one or more entities of the image that includes text. A classification of the text of the one of the plurality of entities of the image may be predicted. The classification of the text may be output. A request to perform an action based upon the classification of the text may be received. The request may include a gesture, a touch input, or a selection. The action may be performed in accordance with the request. An action may refer to, without limitation, making a telephone call, adding contact information, storing information to the computer readable device; searching the Internet, preparing an email message, navigating to a home address, preparing a text message, and opening a web browser to a web page.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 is an example of a system for identifying an entity in an object and performing an action based upon the identified entity according to an implementation disclosed herein.

FIG. 2 is an example of a business card that includes boundaries over the identified named entities as disclosed herein.

FIG. 3 is an example of a neural network according to an implementation disclosed herein.

FIG. 4 is an example process for performing an action in response to a request that is based upon classification of the text of an image according to an implementation disclosed herein.

FIG. 5 is an example of a process that can be utilized to train the neural network according to an implementation disclosed herein.

FIG. 6 is an example computer or computing device suitable for implementing embodiments of the presently disclosed subject matter.

FIG. 7 shows an example network arrangement according to an embodiment of the disclosed subject matter.

### DETAILED DESCRIPTION

The following discussion is directed to various exemplary implementations. However, one possessing ordinary skill in the art will understand that the implementations disclosed herein have broad application, and that the discussion of any implementation is meant only to be an example of that implementation, and not intended to suggest that the scope of the disclosure, including claims is limited to that implementation.

The disclosed implementations may utilize a neural network to identify a named entity in an object and/or a boundary of a region of an object that contains text corresponding to the named entity. This operation may be performed before an OCR operation, if OCR is performed at all. The text may be classified as a part of named entity recognition and, in some implementations, OCR may be performed on the region of the object within the boundary associated with the named entity. The disclosed implementations may provide a highly efficient process to perform named entity recognition and object classification of text in comparison to only performing OCR or performing OCR before classification of the text.

In some configurations, OCR may be performed subsequent to classification of the text, thereby improving efficiency of the OCR at least because the area required to have OCR performed on it is relatively small, and because the type of text contained in the region can inform the OCR operation. Thus, in contrast to an approach that first performs OCR and then matches the text determined from the OCR operation to a known entity (e.g., performs a dictionary search), the disclosed implementations can identify an entity, and if desired, perform OCR on only the identified entity. This can be less burdensome on computer resources because it can limit the amount of an object that is subjected to OCR, may not require performing a comparison of every entity to known entities, and can make the scope of any such comparison, if desired, narrower. For example, if a named entity identified in an object such as a receipt is a phone number, an OCR operation can be limited to comparing digits to the text on the object. Furthermore, classification of an entity can allow intelligent actions to be performed based upon the classification. For example, if an entity is a phone number, the system can, in response to a request, provide a user interface to call the telephone number.

In some configurations, the object may be inferred based upon the presence of one or more entities with or without OCR, instead of generating object detection models for an infinite number of objects. This can greatly reduce the data collection and training required to identify or classify an object.

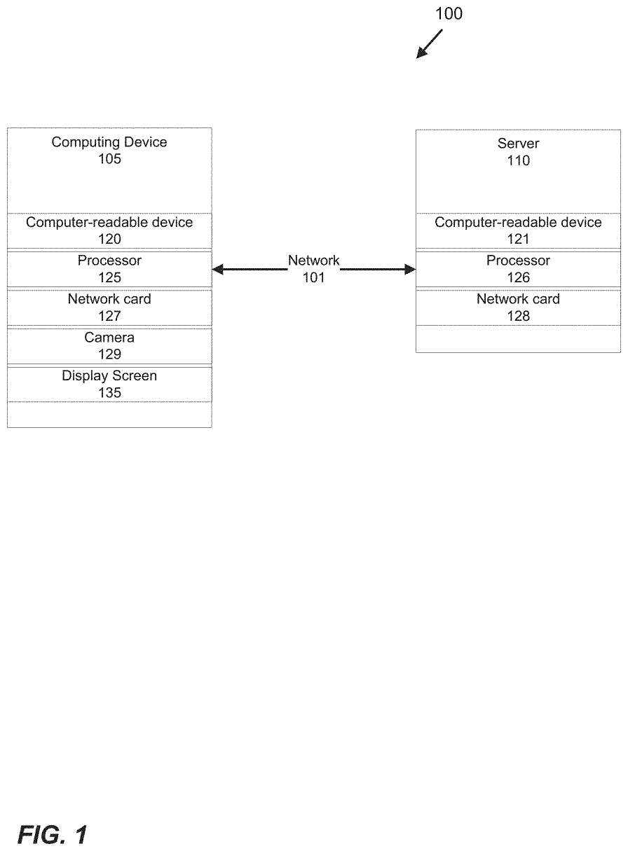

FIG. 1 is an example of a system for identifying an entity in an object and performing an action based upon the identified entity according to an implementation disclosed herein. The system may include one or more computer readable devices 120, 121 that can store computer-readable instructions. The computer-readable device(s) may be communicatively coupled to one or more hardware processors 125, 126. The one or more hardware processors may be configured to execute the instructions stored on the computer readable device(s).

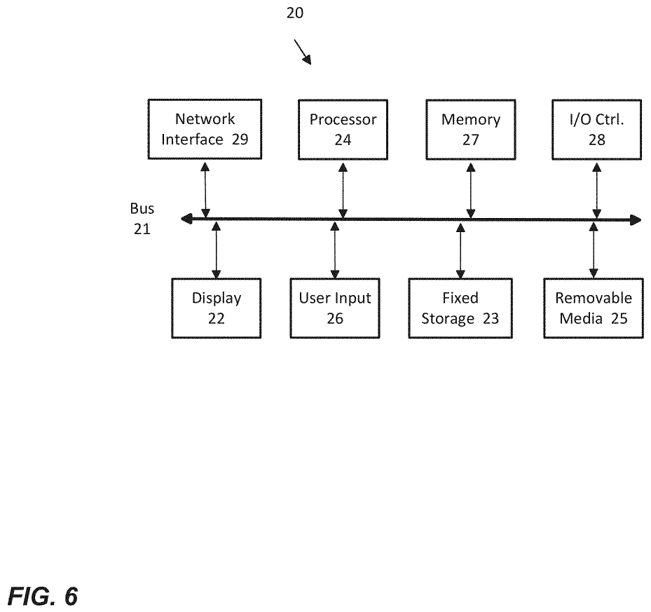

In example illustrated in FIG. 1, the system 100 includes a computing device 105 and a server 110 that are connected via a network 101. A computing device 105 can be a smartphone, a laptop, a tablet, a smartwatch, or the like. A network 101 can refer to, for example, a local area network (LAN), a wide area network (WAN) such as the Internet, any combination thereof, or any combination of connects and protocols that will support communications between the server 110 and the computing device 105. The network 101 may be wired, wireless, fiber optic, satellite based, mesh, etc. A server 110 may refer to a web server, a database, or any other electronic device or computing system capable of receiving and sending data. A server 110 may refer to multiple computers linked in a server system such as a cloud computing environment. A computing device 105 and/or server 110 may include components illustrated in FIG. 6. FIG. 1 is only one illustration of a configuration for the system 100 and is not intended to limit configurations of systems capable of performing the disclosed implementations herein. In FIG. 1, the computing device 105 and the server 110 contain a computer-readable device 120, 121, one or more processors, 125, 126, and a network communication device such network interface card or a wireless card 127, 128. The computing device 105 may also include a camera 129 to perform image capture. In some configurations, a system 100 can be fully contained in a single device 105 or on the server 110. One or more of the operations disclosed herein can be performed on any of the computing device 105 or the server 110. For example, a computing device 105 such as a smartphone may provide an image, and perform entity recognition. Subsequently, one or more portions of the image corresponding to one or more entities may be sent to the server 110 for additional analysis (e.g., OCR and/or object recognition). Similarly, the components included in the computing device 105 and/or server 110 may differ from the example illustrated in FIG. 1. For example, a computing device may not include a camera 129 in some instances (e.g., a laptop computer).

In an implementation, the system 100 may receive an image that includes one or more entities. The image may be a capture of an object such as a receipt, a business card, a paper document, a picture, a cityscape, a standardized form, a letter, a book, a bill, a check, etc.

In some configurations, the implementations may be performed in real time such as in an augmented or virtual reality situation. For example, the camera 129 may show on a display screen 135 of the computing device an object in the camera's field of view. The disclosed operations may be performed on a frame of the camera's field of view in real-time. An image may refer to any type of machine-readable document of any format (e.g., an image, a printable format document, a compressed image or document, etc.).

In some configurations, an image may be stored on the server 110 and provided to the computing device 105 via the network 101. In some instances the computing device 105 may have stored in a computer-readable device 120 an image or the camera 129 may be utilized to capture an image that is stored on the computer-readable device 120. In some instances, the captured image may be stored to the computer-readable device 121 of the server 110.

Regardless of the location of the image (real-time image, computer device 105, or server 110), the image may be received by the computing device 105 or the server 110, which can refer to using the image for subsequent operations. For example, the image may be loaded into a temporary memory of the computing device 105 or server 110. In some instances, receiving the image may refer to the process of digital image capture by the camera 129 on the computing device 105, or receipt by the server 110 of the image from the computing device 105.

A neural network may be used to determine a boundary of one or more entities in the image where the entity contains text. Text may refer to any collection of alphanumeric characters of any language, handwritten text, semantic symbols, mathematical symbols, etc. As an example, an image of an object such as a business card may be provided, and the business card may have several entities such as a name, an email address, a URL, and a phone number. The identity of the object and/or entity may not be known to the neural network prior to evaluating the object. That is, the neural network may not know prior to analysis that a collection of digits corresponds to a phone number, that the collection of digits corresponds to digits, and/or that the object associated with the to-be-determined named entities is a business card. A region of an image, therefore, may be identified as containing text by the neural network, and similarly that a region does not contain text based upon the absence of any logos or lines (e.g., the background of the image is homogenous).

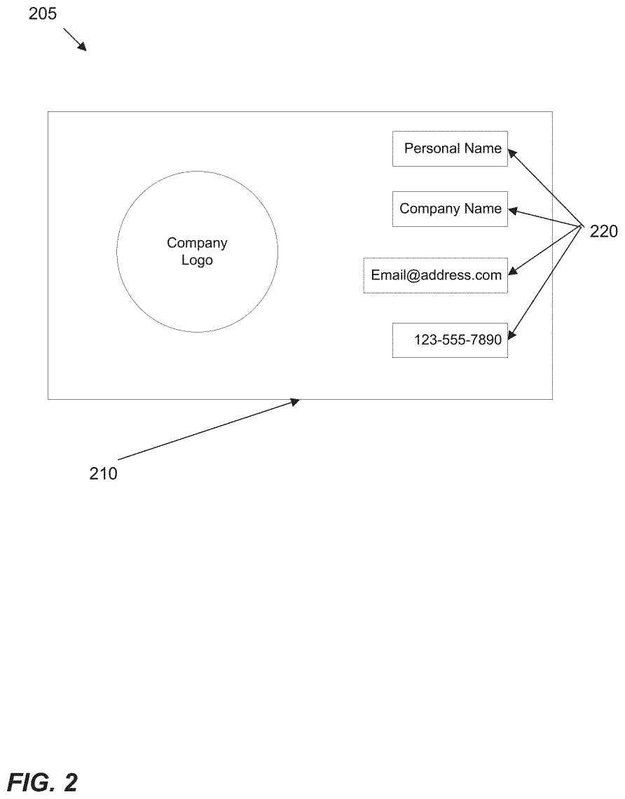

An example of a business card 210 is provided in FIG. 2, with boundaries (e.g., bounding boxes) 220 indicated for each named entity in the business card based upon an image 205 obtained thereof. The boundary 220 does not need to have a rectangular shape. For example, an entity may be encircled with an oval. Thus, to the extent that the neural network is trained using a shape, such a shape may be utilized in lieu of or in addition to a rectangular shape of the boundary 220. As noted above, the implementations disclosed herein are not limited to a business card.

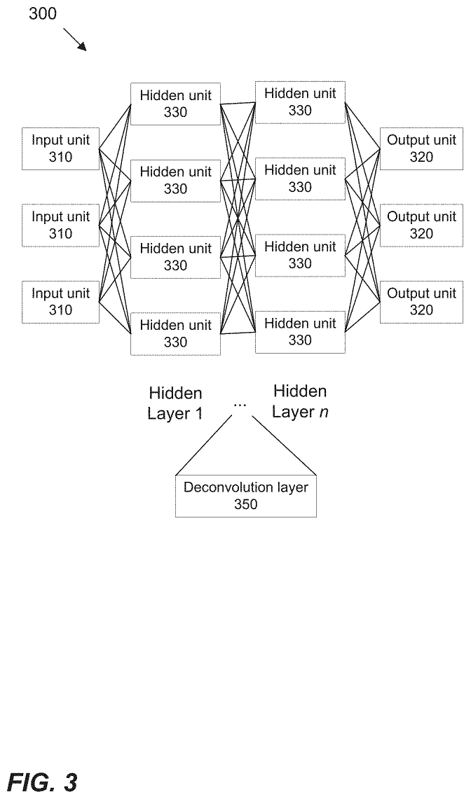

A neural network may refer to an artificial neural network, a deep neural network, a multi-layer neural network, etc. A neural network may refer to a system that can learn to identify or classify features of one or more images without being specifically programmed to identify such features. An example of a neural network is provided in FIG. 3. The neural network may have a series of input units 310, output units 320, and hidden units 330 disposed between the input units 310 and output units 320. Each layer of hidden units 330 may be a node that is interconnected to the previous and subsequent layer. During training of the neural network 300, each of the hidden units 330 may be weighted, and the weights assigned to each hidden unit 330 may be adjusted repeatedly via backpropagation, for example, to minimize the difference between the actual output and known or desired output. Typically a neural network has at least four layers of hidden units 330. Input units 310 may correspond to m features or variables that may have an influence on a specific outcome such as whether a portion of an image contains an edge corresponding to text. The example neural network in FIG. 3 is one example of a configuration of a neural network. The disclosed implementations are not limited in the number of input, output, and/or hidden units 310, 320, 330, and/or the number of hidden layers.

As an example, a neural network such as the You Only Look Once (YOLO) detection system may be utilized. According to this system, detection of an object within the image is examined as a single regression problem from image pixels to a bounding box. The neural network can be trained on a set of known images that contain known identities of entities and/or object classification. An image can be divided into a grid of size S×S. Each grid cell can predict B bounding boxes and confidence for those boxes. These confidence scores may reflect how confident the model is that a given box contains an entity and how accurate the box predicted by the model is. More than one bounding box or no bounding box may be present for any image. If no entity is present in a grid cell, then the confidence score is zero. Otherwise, the confidence score may be equal to the intersection over union between the predicted and ground truth. Each grid cell may also predict C conditional class probabilities which may be conditioned on the grid cell containing an object. One set of class probabilities may be predicted per grid cell regardless of the number of boxes B. The conditional class probabilities and the individual box confidence predictions may be multiplied to provide class-specific confidence scores for each box. These scores can encode both the probability of that class appearing in the box and how well the predicted box fits the entity. As an example, YOLO may utilize a neural network with several convolutional layers, e.g., four or more layers, and filter layers. The final layer may predict one or more of class probabilities and/or bounding box coordinates. Bounding box width and height may be normalized by the image width and height to fall between 0 and 1, and the x and y coordinates of the bounding box can be parameterized to be offsets of a particular grid cell location also between 0 and 1. The disclosed implementations are not limited to any particular type of neural network such as a deep learning neural network, a convolution neural network, a deformable parts model, etc.

A neural network may have several inputs 310 and output units 320 as illustrated in FIG. 3. Input units 310 may communicate information from a source (e.g., an image) to the hidden layers 330. No computation is performed in any of the input units 310. The number of output units 320 may be computed by the product of the grid size (e.g., 30×30), classes (e.g., negative or not containing text, name, address, email address, etc.), and anchor (e.g., the number of boxes per grid). Thus, a 30×30 grid with 10 classes and 3 boxes per grid may have 27,000 output units 320. There may be four or more hidden layers and the number of output units 330 may correspond to the number of characters classified. As an example, a number classifier may have 10 output units corresponding to ten digits. If such a neural network predicts a number to be 2, it may output [0, 1, 0, 0, 0, 0, 0, 0, 0, 0]. In the disclosed implementations, a neural network may determine regions of an object as containing text and classify the type of text it is (e.g., as a part of named entity recognition). In a subsequent step, such as in response to a request, it may predict the actual characters that make up the text itself. During training of the neural network, examples of known named entities can be provided to the neural network so that weights can be assigned to each layer. Weights may be randomly assigned to each layer for a naïve neural network (e.g., one that is untrained).

According to an implementation, the neural network may be trained by receiving input images, with each of the input images having known entities, and some of the entities may have a known text. For example, training images may be of various objects as described above, and some of the training images may not contain any text. In some instances, the training images may have graphical representations. A prediction of a bounding box for each of the known entities in the training images may be generated. As explained above with regard to FIG. 3, there may be several hidden layers in the neural network.

A neural network such as YOLO may increase or decrease the size of the bounding box as it progresses through each hidden layer, and can be useful for detecting the presence of visual objects such as a car or an apple in an image. However, text in an object such as a receipt and/or a business card can be relatively small, such as on the order of 5-10 pixels. To address this issue, a deconvolution layer 350 may be added, which increases the grid size in one of the layers closer to the output units 320. For example, if the grid size is 13×13, the deconvolution layer 350 may increase the grid size to 26×26. The deconvolution layer 350 may be placed in a position near the output units 320, but not the final hidden layer (e.g., the last hidden layer before the output units 320). The position of the deconvolution layer can be in any position equal to or greater than the value computed in accordance with (n−(30%×n)), where n is the number of hidden layers. Accordingly, if there are 20 hidden layers, the deconvolution layer may be placed at any position from layer 14 to 19. By incorporating a deconvolution layer 350 into the neural network, the neural network can analyze smaller entities such as text. By including the deconvolution layer 350 near the end of the neural network, it does not require significant computational resources, but can improve the ability to detect small text. Accordingly, a bounding box for one or more entities in the training input can be determined for the known images.

Returning to the example illustrated in FIG. 1, the system 100 may receive an input image and determine a boundary of one or more entities of the image using a neural network such as the one described above with regard to FIG. 3. The neural network may be trained to predict a classification of a named entity (e.g., as a phone number, a URL, a formal name, a business name, an address, an email address, a fax number) without “knowing” what the actual text is. The classification can be output by the system 100. A prediction, for example, may be stored in the form of a hash table that includes the coordinates of the entity and/or the associated boundary, and/or a classification thereof. Coordinates may be relative to the received image. Such a hash table may be stored in the computer-readable device 120, 121. Generation of the hash table and/or storage in the system 100 may constitute an output of the neural network. Other suitable machine-readable tables or forms for the classification may be utilized in accordance with the implementations disclosed herein. In some configurations, the output may be visual representation of one or more boundaries of one or more classified entities. In some configurations, the output may be storing a list of the information to a format provided by an application. In some configurations, an output may be a list that is visually presented to a user. For example, the system may output a list in a table format that provides the image of the classified entity, and the predicted classification.

As noted with regard to the example illustrated in FIG. 2, one or more boundaries may be visually indicated on the image that encompasses some or all of a classified entity. In some configurations, different boundaries may have a different visual indication. For example, a boundary for a phone number may have a blue bounding box, while a boundary for an email address may have a red bounding box. A visual indication may refer to a visual representation of a shape that encompasses all or the majority of an entity. Such a visual representation may be in the form of a shape (e.g., a rectangle, an oval, a star), a color (e.g., a highlighting), a label (e.g., a number or other such text may be shown adjacent to each boundary or entity), underlining, any combination of the aforementioned indications, etc. In general, each boundary may encompass a single entity. In some instances, the proximity of entities in an object may cause some overlap of boundaries.

The system 100 may receive a request to perform an action based upon the classification of the text. A request may refer to a selection of a boundary (e.g., a boundary box) for an entity. As an example, if a boundary box is visually indicated around a phone number, any region including and/or inside of the boundary box may be selected. Any visual indication may be selected. For example, a series of digits may be classified as a phone number, and a text label such as “phone number” may be indicated near or adjacent to the series of digits on the image. A user may select the text label. A selection may be made by a mouse input, a touch input, a gesture, a verbal command (e.g., a user stating “phone number” for a series of digits classified as such), a peripheral device input (e.g., a stylus), etc. A request may be made in instances where no visual indication of an entity is displayed on the computing device 105. For example, a request may correspond to a gesture, a touch input, a verbal command, etc. directed towards one of the entities (e.g., tapping on the entity classified as the phone number). In some configurations, the computing device 105 may communicate the request to the server 110 via the network 101 connection.

As an example, the image of a business card captured by the computing device 105 may show, after analysis by the neural network, a variety of bounding boxes corresponding to different classified entities on a display 135 of the computing device 105. A user may touch the bounding box that encompasses an entity classified as an email address to request an action to be performed using the email address. At this stage, the specific characters that make up the text of the email address may not be identified.

In response to the request, an action may be performed by the system 100. For example, the system 100 may perform OCR on a region within a boundary associated with a classified entity. If the entity is a phone number, only the region corresponding to the phone number may be analyzed via OCR to determine the identity of the digits of the phone number. In this manner, only the portion of the object (e.g., image) corresponding to the named entity may be analyzed via OCR, which can significantly reduce the computational resources and time required to identify specific characters of text. Further, because the OCR model may be provided with contextual information, it may further expedite the OCR operation. For example, the OCR model can be provided with context information about entity, such as it corresponding to a phone number, then the OCR model can be instructed to match digits to the entity or boundary containing the entity instead of utilizing an entire dictionary of characters. OCR, as disclosed herein, may be performed subsequent to classification of an entity and/or to a request.

The disclosed implementations can enable intelligent actions based upon the classified entities. An action may refer to an operation performed by the system 100 in response to the request. For example, the system 100 may be directed to make a telephone call using the computing device 105. If a named entity is classified as a telephone number, a user may select the visual indication surrounding the telephone number, and the system 100 may utilize the cellular radio or the network connection to make a telephone call to the number. In such a configuration, the system 100 may perform OCR on the telephone number so that the digits of the telephone number may be identified and used. In some instances, information in an image may be stored to a computer-readable device 120, 121. For example, a handwritten note on a whiteboard or a page of a book may be captured as the image, analyzed according to the implementations disclosed herein, and a text document may be generated and stored that contains the contents of the handwritten note or book. In some configurations, an email address may be identified as the entity. In response to selection of the email address, an email program may be launched on the computing device, and a new email message may be generated in which the selected email is automatically populated in the “TO” field of the email message. A similar process may be utilized for a text message. If a URL is the selected entity, then an Internet web browser may be launched on the computing device, and the URL may be immediately searched or entered into the web address field of the browser. In some configurations, selection of the entity may perform a search of the text using an Internet search engine. Accordingly, an intelligent action can be taken based upon the classification of the entity to launch or utilize one or more different applications on the computing device 105. This can present a user of the computing device 105 with different actions that can be taken based upon the provided context (e.g., a phone number leads to a telephone interface, an email address may launch an email application, a URL may launch a web application, etc.).

In some configurations, the system 100 may identify the object associated with the one or more entities. The neural network or a different layout-understanding model (e.g., neural network or machine learning algorithm) may be trained to classify objects based upon the presence and/or layout of certain entities. A grocery receipt, as an example, may be identified by the presence of a date, a store name, transactional information (e.g., currency, consumer goods/services, a tax value), and a layout such as a list of items each having a price, and a total price being indicated at the bottom of the object. Similarly, a business card may be classified as such because it may contain a person's name, an email address, a phone number, a company name, etc. The combination of several of these features may result in a prediction that an object is a business card. In some configurations, the action may be based upon the classification of the object. For example, if the object is a business card, and the computing device 105 or server 110 may add the information contained in the business card to a user's contact list by auto-populating information from the business card into a corresponding field (e.g., company name, person's name, email address, etc.). Thus, an intelligent action may be based upon an identity of an object and/or one or more entities in the object.

Furthermore, because classification of the object is not dependent upon “knowing” the makeup of the text of the identified entities (e.g., by performing OCR), the disclosed implementations can classify an object much faster and with fewer computational resources, than alternative processes. The training process for the layout-understanding model can also be improved. For example, training a classifier to recognize a receipt may require thousands of receipts in which the text of the receipts is known. The system can infer the object based upon the presence of known entities. For example, a business card may have a name, address, title, company logo, phone, email address, URL, department, etc., while a receipt may have a date, total, subtotal, etc. The object's identity can be inferred, therefore, based upon the presence of known entities.

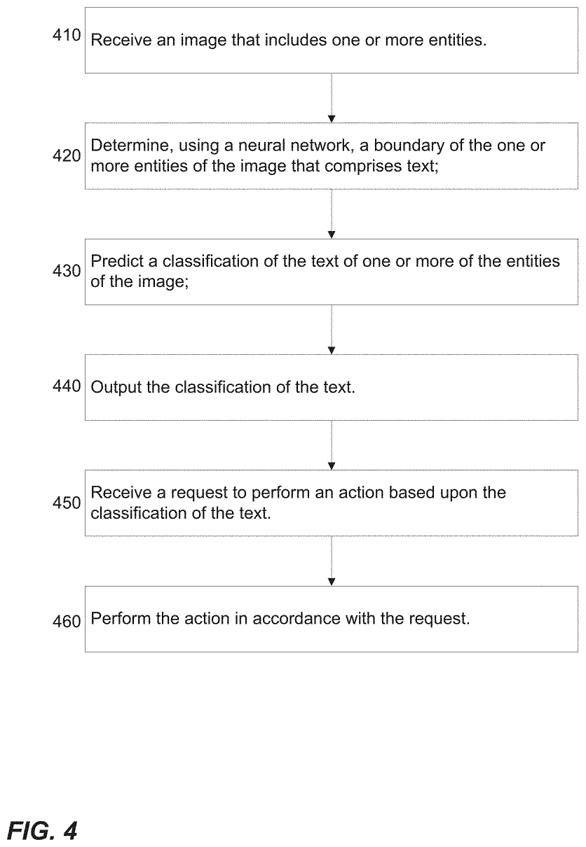

FIG. 4 is an example process for performing an action in response to a request that is based upon classification of the text of an image. The processes illustrated in FIG. 4 may be implemented using any type of computing device and/or hardware processor. In an implementation, an image may be received that includes one or more entities at 410. As explained earlier, the image may refer to any type of machine-readable document and/or a real-time image frame such as may be utilized in an augmented reality or a virtual reality use. A neural network, as described above, may determine a boundary of one or more of the entities in the image that includes text. The boundary may be visually indicated on a screen of a computing device.

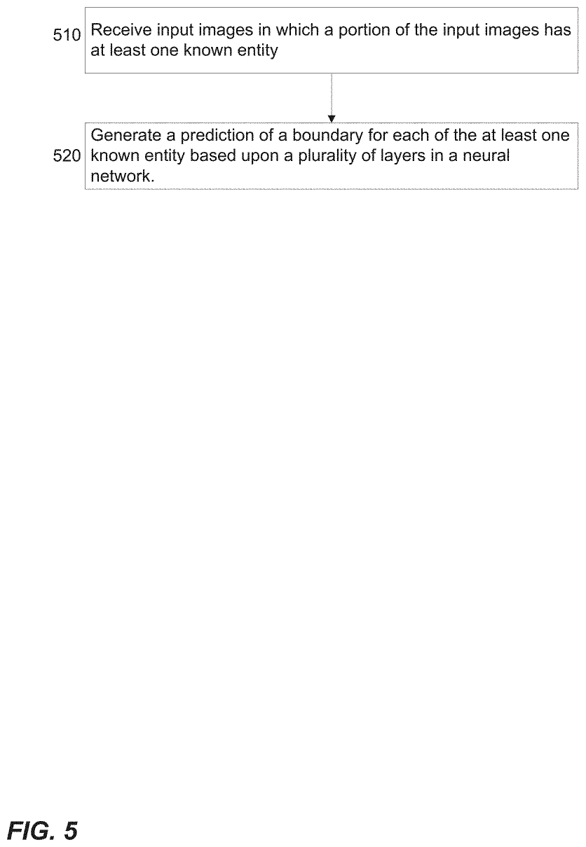

The neural network may be trained utilizing, for example, the process illustrated in FIG. 5. At 510, a neural network such as the example illustrated in FIG. 3 and described above (e.g., YOLO), may receive images as input or training images. The images may have a known classification of any entity within any of the images. In some configurations, the coordinates of a boundary that contains most or all of the entity may be known. Some of the training images may not contain any text and, therefore, not contain a known named entity. The training images may correspond to a particular type of object such as business cards, receipts, handwritten notes/text, etc. The neural network may be configured with a deconvolution layer as explained earlier so that text, which can be relatively small in size, can be analyzed. The neural network may be trained to ignore or discard information about images that do not contain text, as well as information about portions of images that are not predicted to contain text.

At 520, a prediction may be generated for a boundary for each entity in the training image set. The prediction may be compared to known information about the boundary of the entity. In configurations where boundary information about the one or more entities in the training images is unknown, then a boundary may be generated by the neural network based upon the position of the text in the image. For example, a boundary may be fit (e.g., using a process such as YOLO) to encompass most or all of this text.

Returning to the example process in FIG. 4, a boundary for one or more of the entities in the image may be determined using the neural network at 420. The boundary, as explained above, may encompass most or all of an entity. A classification of the text of one or more of the entities of an image may be predicted at 430 using the neural network. In some instances, the classification of the text at 430 and the boundary determination at 420 are performed simultaneously as one process. The classification does not require OCR to have been performed on the image. For example, text may be classified as a phone number, an email address, etc. OCR may be performed as an operation subsequent to the classification process upon receipt of a request as explained earlier, and can be performed on specific portion(s) of the image. Classification of an entity may include determining coordinates of a boundary for the entity. The boundary may include most or all of the entity, and the boundary can have a specific shape (e.g., a rectangle, an oval, etc.). The classification of the text may be output at 440. As mentioned above, the output may be stored in memory as a hash table or any other such suitable format. For example, a table may indicate an image name, coordinates of a bounding box within a given image, the predicted named entity. In some instances, the boundary of the entity may constitute an output and it may be visually indicated as described earlier.

At 450, a request to perform an action based upon the classification of the text may be received. A request may constitute a selection of one of the entities identified in the image. The request may be received by touch, gesture, voice, or other peripheral device input. At 460, the action may be performed in response to the request as explained above. In some instances, a combination of actions may be performed such as where OCR is performed followed by dialing a telephone number.

Embodiments of the presently disclosed subject matter may be implemented in and used with a variety of component and network architectures, or a combination thereof. Implementations disclosed herein may be performed on a computer or computing device 20, a server 13, or a combination of a computer or computing device 20 and a server 13. For example, a smartphone may determine entities in a business card, and then send one or more portions of the image of the business card to a server, which can perform OCR and/or object classification. Thus, the operations disclosed herein may be divided between a server 13 and a computer or computing device 20.

FIG. 6 is an example computer or computing device 20 (e.g., electronic device such as a smartphone, smartwatch, tablet, laptop, personal computer, etc.) suitable for implementing embodiments of the presently disclosed subject matter. The computer 20 includes a bus 21 which interconnects major components of the computer 20, such as a central processor 24, a memory 27 (typically RAM, but which may also include read-only memory (“ROM”), flash RAM, or the like), an input/output controller 28, a user display 22, such as a display screen via a display adapter, a user input interface 26, which may include one or more controllers and associated user input devices such as a keyboard, mouse, camera, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include ROM or flash memory (neither shown), and RAM (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium such as a hard disk drive (e.g., fixed storage 23), an optical drive, floppy disk, or other storage medium 25.

Various functions described herein may be implemented in hardware, software, or any combination thereof. If implemented in software, the functions may be stored on and/or transmitted over as one or more instructions or code on a computer-readable device. A computer-readable device may refer to memory 27, fixed storage 23, and/or removable media 25. A computer-readable device may be any available storage media that may be accessed by a computer (e.g., RAM, ROM, EEPROM, CD-ROM or other optical disk storage, magnetic disk storage or other magnetic storage devices, or any other medium that can be used to store desired program code in the form of instructions or data structures and that can be accessed by a computer). Further, a propagated signal is not included within the scope of computer-readable device. Computer-readable device may also include communication media including any medium that facilitates transfer of a computer program from one place to another.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks. Many other devices or components (not shown) may be connected in a similar manner (e.g., digital cameras or speakers). Conversely, not all of the components shown in FIG. 6 need to be present to practice the present disclosure. The components can be interconnected in different ways from that shown. The operation of a computer such as that shown in FIG. 6 is readily known in the art and is not discussed in detail in this application. Code to implement the present disclosure can be stored in computer-readable device such as one or more of the memory 27, fixed storage 23, removable media 25, or on a remote storage location.

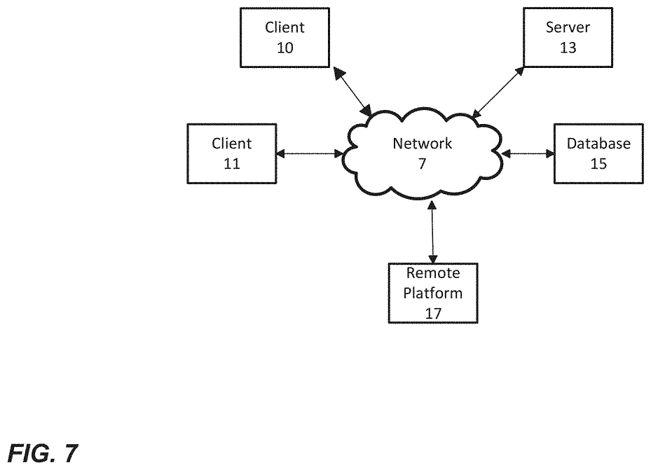

FIG. 7 shows an example network arrangement according to an embodiment of the disclosed subject matter. One or more clients 10, 11, such as computing devices including, but not limited to, local computers, smartphones, smart watches, game consoles, tablet computing devices, and the like may connect to other devices via one or more networks 7. A network may refer to a communication medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio and microwave are included in the definition of communication medium. As described earlier, the communication partner may operate a client device that is remote from the device operated by the user (e.g., in separate locations). The network may be a local network, wide-area network, the Internet, or any other suitable communication network or networks, and may be implemented on any suitable platform including wired and/or wireless networks. The clients may communicate with one or more servers 13 and/or databases 15. A server 13 may include some or all of the components described above with regard to a computer 20 and/or illustrated in FIG. 6. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter.

When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

What is claimed is:

1. A system, comprising:
at least one computer readable device storing instructions;
one or more hardware processors that are coupled to the at least computer readable device and that are configured to execute the instructions to cause the system to perform operations comprising:
receiving an image comprising a plurality of entities;
determining, using a neural network, a boundary of one of the plurality of entities of the image that comprises text;
predicting a classification of the text of the one of the plurality of entities of the image;
outputting the classification of the text;
receiving a request to perform an action based upon the classification of the text; and
performing the action in accordance with the request.

2. The system of claim 1, wherein the operations further comprise performing optical character recognition on only a region within the boundary.

3. The system of claim 1, wherein the optical character recognition is performed subsequent to the request.

4. The system of claim 1, wherein the action is selected from the group consisting of: making a telephone call, adding contact information, storing information to the computer readable device; searching the Internet, preparing an email message, navigating to a home address, preparing a text message, and opening a web browser to a web page.

5. The system of claim 1, wherein the operation further comprise visually indicating the boundary of the one of the plurality of entities of the image; or visually indicating the one of the plurality of entities of the image.

6. The system of claim 4, wherein the request comprises a selection of the visual indication.

7. The system of claim 1, wherein the request comprises a gesture, a touch input, or a selection.

8. The system of claim 1, wherein the neural network is created by operations comprising:
receiving a plurality of input images, a portion of the plurality of input images comprising at least one known entity; and
generating a prediction of a boundary for each of the at least one known entity based upon a plurality of layers in a neural network, wherein one of the plurality of layers comprises a deconvolution layer.

9. A computer-implemented method, comprising:
receiving an image comprising a plurality of entities;
determining, using a neural network, a boundary of one of the plurality of entities of the image that comprises text;
predicting a classification of the text of the one of the plurality of entities of the image;
outputting the classification of the text;
receiving a request to perform an action based upon the classification of the text; and
performing the action in accordance with the request.

10. The method of claim 9, further comprising performing optical character recognition on only a region within the boundary.

11. The method of claim 9, wherein the optical character recognition is performed subsequent to the request.

12. The method of claim 9, wherein the action is selected from the group consisting of: making a telephone call, adding contact information, storing information to the computer readable device; searching the Internet, preparing an email message, navigating to a home address, preparing a text message, and opening a web browser to a web page.

13. The method of claim 10, further comprising visually indicating the boundary of the one of the plurality of entities of the image; or visually indicating the one of the plurality of entities of the image.

14. The method of claim 13, wherein the request comprises a selection of the visual indication.

15. The method of claim 9, wherein the request comprises a gesture, a touch input, or a selection.

16. The method of claim 9, wherein the neural network trained by the following processes:
receiving a plurality of input images, a portion of the plurality of input images comprising at least one known entity; and
generating a prediction of a boundary for each of the at least one known entity based upon a plurality of layers in a neural network, wherein one of the plurality of layers comprises a deconvolution layer.

17. A computer readable device, storing machine-readable instructions that, when executed by one or more processors, cause the one or more processors to:
receive an image comprising a plurality of entities;
determine, using a neural network, a boundary of one of the plurality of entities of the image that comprises text;
predict a classification of the text of the one of the plurality of entities of the image;
output the classification of the text;
receive a request to perform an action based upon the classification of the text; and
perform the action in accordance with the request.

18. The computer readable device of claim 17, wherein the operations further comprise performing optical character recognition on only a region within the boundary.

19. The computer readable device of claim 17, wherein the optical character recognition is performed subsequent to the request.

20. The computer readable device of claim 17, wherein the operation further comprise visually indicating the boundary of the one of the plurality of entities of the image; or visually indicating the one of the plurality of entities of the image.
